(19) United States
(12) Patent Application Publication
(10) Pub. No.: US 2009/0297883 A1
(43) Pub. Date: Dec. 3, 2009

(54) METALLIC COMPOSITE WIRE WITH AT LEAST TWO METALLIC LAYERS

(75) Inventors: Ewald Koppensteiner, St. Florian (AT); Rudolf Schrayvogel, St. Leonhard (AT)

Correspondence Address: LERNER GREENBERG STEMER LLP, P O BOX 2480, HOLLYWOOD, FL, 33022-2480, US

(73) Assignee: GEBAUER & GRILLER METALLWERK GMBH, Wien (AT)

(21) Appl. No.: 12/472,698

(22) Filed: May 27, 2009

(30) Foreign Application Priority Data
May 29, 2008 (AT) A 871/2008

(51) Int. Cl. B32B 15/20

(52) U.S. Cl. 428/675

(57) ABSTRACT

A metallic composite wire has at least two metallic layers. One layer, preferably the inner layer, is a non-ferrous metal alloy. A second layer, preferably the outermost layer, consists of copper.

### CROSS-REFERENCE TO RELATED APPLICATION

This application claims the priority, under 35 U.S.C. § 119, of Austrian patent application A 871/2008, filed May 29, 2008; the prior application is herewith incorporated by reference in its entirety.

### BACKGROUND OF THE INVENTION

### Field of the Invention

The invention relates to a metallic composite wire having at least two metallic layers.

Various applications demand electrical conductors and wires with good electrical properties, i.e., low resistance, and high mechanical strength, in particular high tensile strength and fatigue strength under reversed bending stresses. These conductors and wires should additionally be corrosion-resistant.

Known products include CCS (copper clad steel) composite wires, CCA (copper clad aluminum) composite wires, ACS (aluminum clad steel) composite wires, ICN (iron clad nickel) composite wires and also Dumet composite wires (copper clad FeNi42/47), but these are often not sufficiently corrosion-resistant and do not have the desired mechanical properties. These are composite wires with a core wire which is made from steel, FeNi42/47, pure nickel or aluminum and is sheathed with a layer made from copper, aluminum or iron. A core wire of this type corrodes very quickly if it is exposed to a corrosive medium such as, for example, salt water, and this means that composite wires of this type cannot be used in various applications. CCA composite wires have the further disadvantage of low strength.

### SUMMARY OF THE INVENTION

It is accordingly an object of the invention to provide a metallic composite wire, which overcomes the above-mentioned disadvantages of the heretofore-known devices and methods of this general type and which meets the demands as outlined in the introductory text above as effectively as possible.

With the foregoing and other objects in view there is provided, in accordance with the invention, a metallic composite wire, comprising at least two metallic layers, including at least one layer of a non-ferrous metal alloy. In a preferred development, there is provided an outer layer consisting of copper, and the layer that is made from the non-ferrous metal alloy is an inner layer.

Other features which are considered as characteristic for the invention are set forth in the appended claims.

Although the invention is described herein as embodied in a metallic composite wire, it is nevertheless not intended to be limited to the specifically described details, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the various examples provided below.

### DETAILED DESCRIPTION OF THE INVENTION

The use of a non-ferrous metal alloy for at least one layer and preferably copper for a second layer makes it possible to produce composite wires which meet the demands mentioned in the introduction. More specifically, this alloy and second layer (preferably copper layer) can be coordinated with one another in such a way that the tensile strength, the fatigue strength under reversed bending stresses and also the conductivity are sufficiently high. It is also possible to establish a good bond between the individual layers, and this is important for the strength properties of the composite wire. The selection of the alloying constituents also makes it possible to achieve high corrosion resistance in corrosive media, for example salt-containing aqueous media, specifically because not only are the two individual components each highly resistant, but also both components can be found close to one another in the electrochemical series, and therefore the susceptibility to corrosion is very low even in the presence of electrolytes.

In a preferred embodiment of the invention, one layer made from the non-ferrous metal alloy is an inner layer and one outer layer is a copper layer. The advantage of this embodiment is that the technologies used for connecting the electrical conductors or wires to electrical connectors, cable clamps and the like, which are coordinated with copper wires, can be used further in an unmodified form.

The proportion of the total cross-sectional area of the composite wire taken up by the layer made from Cu is preferably 20-80%, more preferably 65-70%. Given an areal proportion of Cu in these ranges, it is possible to achieve both favorable mechanical properties and electrical properties, and it is also readily possible for the composite wire to be processed further, as mentioned above.

The metallic composite wire according to the invention preferably has a round cross section since this cross-sectional form is used very frequently. In this case, it is preferable for the core layer to consist of the non-ferrous metal alloy and for the outermost layer to consist of copper. The demands made can be met particularly effectively with a composite wire of this type.

However, other cross-sectional forms are also conceivable, for example in the form of flat or profiled wires, and also strips.

The metallic composite wire according to the invention is used with preference in signal lines in the construction of motor vehicles, and therefore preferably has a cross-sectional area of 0.05 to 0.5 mm². The non-ferrous metal alloy preferably contains the following constituents in the amounts stated (in % by weight):

| | |
|---|---|
| Ni | 3.0% to 28% |
| Fe | 1.5% to 15% |
| Mn | 1.5% to 10% |
| Cu | remainder, |

the sum of the amounts selected being 100% by weight, since an alloy having the specified constituents in the specified ranges meets the demands made in the introduction particularly effectively.

The non-ferrous metal alloy particularly preferably contains the following constituents in the amounts stated (in % by weight):

| | |
|---|---|
| Ni | 5.0% to 20% |
| Fe | 2.0% to 12% |
| Mn | 2.0% to 8% |
| Cu | remainder, |

the sum of the amounts selected being 100% by weight.

The non-ferrous metal alloy very particularly preferably contains the following constituents in the amounts stated (in % by weight):

| | |
|---|---|
| Ni | 6.0% to 13% |
| Fe | 2.1% to 8% |
| Mn | 2.5% to 6% |
| Cu | remainder, |

the sum of the amounts selected being 100% by weight.

In a particularly preferred exemplary embodiment of the invention, the non-ferrous metal alloy contains the following constituents in the amounts stated (in % by weight):

| | |
|---|---|
| Ni | 7.620% |
| Fe | 3.570% |
| Mn | 3.760% |
| C | 0.002% |
| Si | 0.023% |
| Mg | 0.015% |
| Ti | 0.310% |
| S | 0.007% |
| P | 0.002% |
| Cu | 84.691%. |

A composite wire of this type has the following mechanical values:
in the soft-annealed state: very good ductility (after annealing at 700° C., elongation at break A₂₀₀=27%), with simultaneously relatively low strength (370 MPa) and yield strength (220 MPa),
in the hard-drawn state: low ductility (A₂₀₀=1%), but therefore high strength (640 MPa) and yield strength (600 MPa).

There are applications which demand not only good overall corrosion properties but also mechanical values which cannot be achieved when the two components of this composite wire are either in the soft-annealed state or in the cold work-hardened state, but can be achieved when specifically only the external Cu in this composite wire is soft annealed, but the internal core is not recrystallized.

This can be achieved either by stationary annealing (T=200-500° C.) or by in-line annealing (conductive, inductive, etc.) at rates and temperatures which depend on the diameter; both these processes take place in a non-oxidizing atmosphere.

A composite wire having constituents in accordance with the above example, in which one component is soft and the other is hard, has the following mechanical values (external diameter 0.40 or 0.50 mm):

Strength=450 MPa, yield strength=350 MPa, A₂₀₀=12%.

A prerequisite for this is the outstanding metallic adhesion that can be achieved with the invention between the two components in the composite wire. The two components can therefore “assist one another,” and it is therefore possible to provide an average of the mechanical values of the two components which can additionally be set in targeted fashion by the selection of the proportions by volume and by the selection of the materials.

Since the elongation at break is correlated, for example, with the fatigue strength under reversed bending stresses, the latter can also be set in targeted fashion in composite wires of this type with hard and soft components. In the example above, the bare composite wires with a diameter of 0.40 or 0.50 mm have a high fatigue strength under reversed bending stresses of considerably >300 bends (through 1800, over a mandrel of 10 mm, at a loading weight of 200 g at 60 cycles per minute) until breakage occurs.

Depending on the selection of the components in the composite having two or more components, one inner component can optionally also be soft annealed while the others retain the hardness of deformation, as long as the recrystallization temperatures of the components differ sufficiently.

The composite wire according to the above example has an electrical resistivity of 0.026 ohm mm²/m, corresponding to approximately 38.5 S.U. (Siemens' Units) and therefore approximately 65% IACS, that is to say approximately 65% of the conductivity of copper.

On account of this combination of its corrosive, electrical and mechanical properties, the composite wire having constituents in accordance with the above example in the internally hard variant may be used, for example, as a conductor in cables and lines, preferably where signal currents (low current intensity) are to be conducted and where the exposure of the conductor to aggressive media (e.g. salt spray water) in the contact area cannot be precluded.

Since this composite wire is not only either ductile or solid but also has a combination of both properties, it is also suitable, in the form of an individual conductor, as a replacement for a Cu braided wire with a relatively large cross section, while maintaining the required conductivity, sufficient ductile properties (such as fatigue strength under reversed bending stresses) and a strength/yield strength which is comparable with that of a Cu braided wire with a relatively large cross section.

By way of example, a composite wire of this type with an external diameter of 0.50 mm/a cross section of 0.22 mm² is thus suitable as a replacement for a Cu braided wire with a total cross section of 0.50 mm²; a composite wire of this type with an external diameter of 0.40 mm/a cross section of 0.13 mm² or even one with an external diameter of 0.30 mm/a cross section of 0.07 mm² may replace, for example, a Cu braided wire with a total cross section of 0.35 mm².

This makes it possible to make a substantial saving on material, space and weight, and this is advantageous for various applications.

In the cross-section ranges ≦0.50 mm², disruptive long-term effects (loosening of the connection/of the crimp connection) also generally occur at the contacted ends of Cu braided wires or braided wires. These effects have not been observed when using individual wires, and this represents a further significant advantage of individual wires over braided wires.

1. A metallic composite wire, comprising at least two metallic layers, including at least one layer of a non-ferrous metal alloy.

2. The metallic composite wire according to claim 1, which comprises an outer layer consisting of copper.

3. The metallic composite wire according to claim 1, wherein one layer made from said non-ferrous metal alloy is an inner layer.

4. The metallic composite wire according to claim 2, wherein said composite wire has a total cross-sectional area, and a proportion of the total cross-sectional area taken up by said layer made of copper is 20-80%.

5. The metallic composite wire according to claim 4, wherein the proportion of the copper layer is 65-70% of the total cross-sectional area.

6. The metallic composite wire according to claim 1, formed to have a substantially round cross section.

7. The metallic composite wire according to claim 6, wherein an innermost layer consists of said non-ferrous metal alloy and an outermost layer consists of copper.

8. The metallic composite wire according to claim 1, formed with a cross-sectional area of 0.05 to 0.50 mm².

9. The metallic composite wire according to claim 1, wherein said non-ferrous metal alloy contains the following constituents in the following amounts, in % by weight:

| | |
|---|---|
| Ni | 3.0% to 28% |
| Fe | 1.5% to 15% |
| Mn | 1.5% to 10% |
| Cu | remainder; and |

with a sum of the amounts selected being 100% by weight.

10. The metallic composite wire according to claim 9, wherein said non-ferrous metal alloy contains the following constituents in the following amounts, in % by weight:

| | |
|---|---|
| Ni | 5.0% to 20% |
| Fe | 2.0% to 12% |
| Mn | 2.0% to 8% |
| Cu | remainder; and |

with a sum of the amounts selected being 100% by weight.

11. The metallic composite wire according to claim 10, wherein said non-ferrous metal alloy contains the following constituents in the following amounts, in % by weight:

| | |
|---|---|
| Ni | 6.0% to 13% |
| Fe | 2.1% to 8% |
| Mn | 2.5% to 6% |
| Cu | remainder; and |

with a sum of the amounts selected being 100% by weight.

12. The metallic composite wire according to claim 1, wherein said non-ferrous metal alloy contains the following constituents in the following amounts, in % by weight:

| | |
|---|---|
| Ni | 7.620% |
| Fe | 3.570% |
| Mn | 3.760% |
| C | 0.002% |
| Si | 0.023% |
| Mg | 0.015% |
| Ti | 0.310% |
| S | 0.007% |
| P | 0.002% |
| Cu | 84.691%. |

13. The metallic composite wire according to claim 2, wherein said outer layer made of copper is a soft-annealed layer, and an internal layer made from said non-ferrous metal alloy is a non-recrystallized layer.
